(19) United States
(12) Patent Application Publication
(10) Pub. No.: US 2009/0201123 A1
(43) Pub. Date: Aug. 13, 2009

(54) SENSOR NETWORK FOR LIQUID DRAINAGE SYSTEMS

(76) Inventors: Eddy Kafry, Hod Hasharon (IL); Zohar Azani, Ramat Gan (IL); Bat-Sheva Ovadia, Hod Hasharon (IL); Zeev Inbar, Tel Aviv (IL); Oren Davidi, Ramat Gan (IL)

Correspondence Address: DANIEL J SWIRSKY, 55 REUVEN ST., BEIT SHEMESH, 99544, IL

(21) Appl. No.: 12/369,881

(22) Filed: Feb. 12, 2009

Related U.S. Application Data
(60) Provisional application No. 61/028,216, filed on Feb. 13, 2008.
(60) Provisional application No. 61/102,928, filed on Oct. 6, 2008.

(51) Int. Cl. G05B 23/02; H04B 3/36

(52) U.S. Cl. 340/3.32; 340/3.1; 455/7

(57) ABSTRACT

A manhole monitoring unit includes a housing mountable to walls of a closed manhole, without breaching an insulating layer on the walls, a data processor to receive data from monitoring sensors in the manhole, and a communication unit at least for transmitting wirelessly the data to an external network unit located above ground. A manhole monitoring and control unit includes a housing mountable to walls of a closed sewage manhole, without breaching the walls, a data processor to receive data from monitoring sensors in the manhole and to control actuators according to high level network commands, and a communication unit for transmitting wirelessly the data to an external network unit located above ground and receiving commands.

### CROSS-REFERENCE TO RELATED APPLICATIONS

This application claims benefit from U.S. Provisional Patent Application No. 61/028,216, filed Feb. 13, 2008, and U.S. Provisional Patent Application No. 61/102,928, filed Oct. 6, 2008, which are hereby incorporated in their entirety by reference.

### FIELD OF THE INVENTION

The present invention relates to sensor networks for monitoring and control of liquid drainage systems generally and to wireless implementation of such networks in particular.

### BACKGROUND OF THE INVENTION

Electronic systems for monitoring the status of liquid drainage systems, such as sewage and wastewater systems, are known in the art. Such systems typically comprise a multitude of remote sensor installations that may be linked by a communication network to provide monitoring data on the level and flow of the system's contents. Each installation comprises one or more different sensors to provide a single or a variety of data points such as water level, toxicity, acidity, flow rate or an indication that an access point is open.

FIG. 1, to which reference is now made, illustrates a typical such sensor installation 100 installed to monitor a sewage system. Sewage line 10 is located underneath ground 25, with manhole 20 providing access from the surface. Manhole 20 comprises insulated walls 21 and manhole cover 30. It will be appreciated that the use of sewage line 10 may be exemplary; such systems may also be used for non sewage wastewater as well.

Sensor pack 40 is attached to wall 21 in such manner as to allow its sensors (not shown) to monitor sewage parameters that are accessible within manhole 20. Access line 45 connects sensor pack 40 to remote network unit 50. Sensor pack 40 is waterproofed and uses a data cable (not shown) in access line 45 to forward sensor data to unit 50. The sensor data can then be collected directly from unit 50 or alternatively forwarded to a central location. For example, Unit 50 can forward the data over network 60 via network line 55.

Sensor pack 40 is typically powered by electrical input received from unit 50.

U.S. patent application Ser. No. 11/944,329 discloses a monitoring system including a remote monitoring station that communicates wirelessly with monitoring devices placed in manhole cavities and positioned in close proximity to the manhole.

### SUMMARY OF THE PRESENT INVENTION

An object of the present invention is to improve the prior art.

There is therefore, in accordance with a preferred embodiment of the present invention, a manhole monitoring unit including a housing mountable to walls of a closed manhole, without breaching an insulating layer on the walls, a data processor to receive data from monitoring sensors in the manhole, and a communication unit at least for transmitting wirelessly the data to an external network unit located above ground.

Further, in accordance with a preferred embodiment of the present invention, the sensors comprise functionality to provide at least one of the following types of data threshold level condition, water depth, toxicity, acidity, flow rate and whether the closed manhole has been opened.

Still further, in accordance with a preferred embodiment of the present invention, the housing is mounted using at least one of the following adhesive, screws and an assembly for attachment to a ladder.

Additionally, in accordance with a preferred embodiment of the present invention, the communication unit includes means to at least communicate with at least one other the manhole monitoring unit.

Moreover, in accordance with a preferred embodiment of the present invention, the at least one other manhole monitoring unit is located in at least one of the following locations: the manhole and at least one other manhole.

Further, in accordance with a preferred embodiment of the present invention, the data processor includes means to control actuators according to high level network commands.

Still further, in accordance with a preferred embodiment of the present invention, the unit also includes means to receive an activation signal.

Additionally, in accordance with a preferred embodiment of the present invention, the means are at least one of the following: a wireless receiver, a magnet sensor and an activation switch.

Moreover, in accordance with a preferred embodiment of the present invention, the unit also includes means to request and receive confirmation of the activation signal.

There is also provided in accordance with a preferred embodiment of the present invention, a manhole monitoring and control unit including a housing mountable to walls of a closed sewage manhole, without breaching the walls, a data processor to receive data from monitoring sensors in the manhole and to control actuators according to high level network commands, and a communication unit for transmitting wirelessly the data to an external network unit located above ground and receiving commands.

Further, in accordance with a preferred embodiment of the present invention, the sensors comprise functionality to provide at least one of the following types of data threshold level condition, water depth, toxicity, acidity, flow rate and whether the closed manhole has been opened.

Still further, in accordance with a preferred embodiment of the present invention, the housing is mounted using at least one of the following adhesive, screws and an assembly for attachment to a ladder.

Additionally, in accordance with a preferred embodiment of the present invention, the communication unit includes means to at least communicate with at least one other the manhole monitoring unit.

Moreover, in accordance with a preferred embodiment of the present invention, the at least one other manhole monitoring unit is located in at least one of the following locations: the manhole and at least one other manhole.

Further, in accordance with a preferred embodiment of the present invention, the unit also includes means to receive an activation signal.

Still further, in accordance with a preferred embodiment of the present invention, the means are at least one of the following a wireless receiver, a magnet sensor and an activation switch.

Additionally, in accordance with a preferred embodiment of the present invention, the unit also includes means to request and receive confirmation of the activation signal.

There is also provided in accordance with a preferred embodiment of the present invention, a remote network unit including a communication unit to relay a transmission from a manhole monitoring unit to a network, rechargeable batteries, and a solar panel to provide power to the network unit and charge the batteries.

Further, in accordance with a preferred embodiment of the present invention, the communication unit includes a wireless receiver to receive the transmission from a manhole monitoring unit, and a network communication unit to connect to the network via a connection, the connection being at least one of wireless and cable.

Still further, in accordance with a preferred embodiment of the present invention, the network is at least one of a WiFi wireless network, WiMAX wireless network, a cellular network, an Ethernet network, a ZigBee network or a wireless sensor network.

There is also provided, in accordance with a preferred embodiment of the present invention, a method for monitoring liquid drainage in a manhole including receiving on a communications unit monitoring data from at least one sensor pack located in the manhole, where the communications unit is located in the manhole, and sending the data via wireless transmission to a remote network unit for relay to a central control center.

Further the method also includes receiving at least one transmission of monitoring data from a second communications unit, the second communications unit located in at least one of the following locations the manhole and at least one other the manhole.

Still further, in accordance with a preferred embodiment of the present invention, the sending includes transmitting the monitoring data to a second communications unit, the second communications unit located in at least one of the following locations the manhole and at least one other the manhole.

Additionally, in accordance with a preferred embodiment of the present invention, the method also includes periodically entering a dormant state to conserve use of resources.

Moreover, in accordance with a preferred embodiment of the present invention, the method also includes transmitting the monitoring data in response to a threshold event indicated by the monitoring data.

Further, in accordance with a preferred embodiment of the present invention, the method also includes defining at least one event window for ignoring repeated changes of states for the threshold event.

Still further the method also includes defining different lengthed the event windows for the beginning and end of a non normal state for the threshold event.

Additionally, in accordance with a preferred embodiment of the present invention, the sending includes storing the monitoring data and, transmitting the stored monitoring data on a periodic basis.

Moreover, in accordance with a preferred embodiment of the present invention, the method also includes storing the monitoring data, summarizing the stored monitoring data, and transmitting the summarized stored monitoring data on a periodic basis.

Further, in accordance with a preferred embodiment of the present invention, the method also includes receiving an activation signal to commence operation.

Still further, in accordance with a preferred embodiment of the present invention, the receiving an activation signal includes at least one of the following detecting a magnet, receiving a wireless signal, and detecting a change in an activation switch.

Additionally, in accordance with a preferred embodiment of the present invention, the method also includes controlling actuators according to high level network commands.

Moreover, in accordance with a preferred embodiment of the present invention, the method also includes receiving a second set of the monitoring data on a second communications unit located in the manhole.

Further, in accordance with a preferred embodiment of the present invention, the receiving of the second set is continuous.

Still further, in accordance with a preferred embodiment of the present invention, the method also includes activating the second communications unit in the event of failure of the first communications unit.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a prior art sewage monitoring installation.

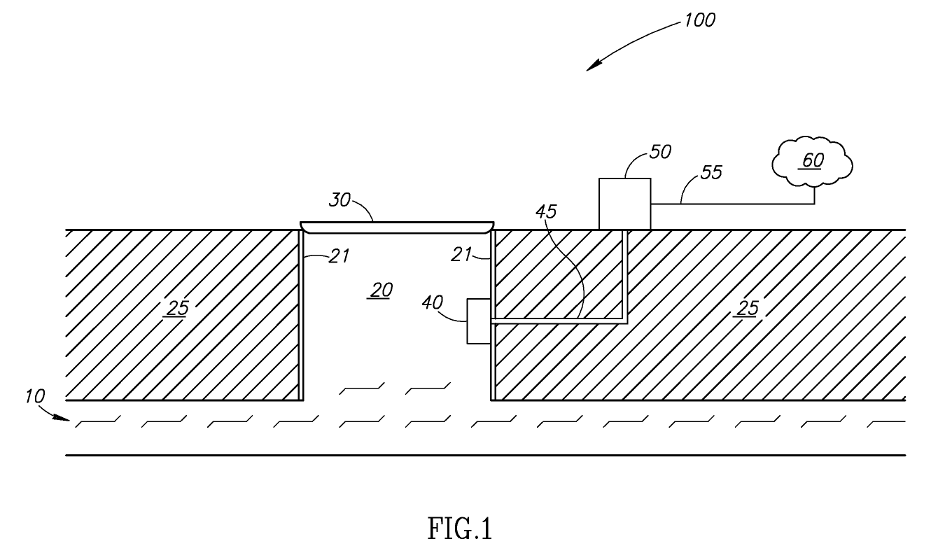

FIGS. 2A and 2B are schematic illustrations of novel wireless sensor installations, designed and constructed in accordance with a preferred embodiment of the present invention.

FIG. 3 is a block diagram of the electronic elements of an exemplary communication unit for use in the installation of FIGS. 2A and 2B.

FIG. 4A is an illustration of exemplary transmission timeline of synchronous/asynchronous transmissions by the unit of FIG. 3.

FIG. 4B is an exemplary graph of the water level in a manhole the installation of FIGS. 2A and 2B over time.

FIG. 5 is a schematic illustration of a novel wireless sensor installation, designed and constructed in accordance with a preferred embodiment of the present invention.

FIGS. 6A and 6B are schematic illustrations of the unit of FIG. 3.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

It will be appreciated that installing system 100 affects the overall integrity of an existing manhole 20, as insulated walls 21 are breached as part of the installation process. The drilling process also requires non-trivial costs in labor and equipment. Furthermore, network unit 50 is typically positioned on the ground close to manhole 20, thus exposing it to damage by passersby, either intentionally or otherwise. If, for whatever reason, network unit 50 is located at a distance from manhole 20 (for example, manhole 20 is located in the middle of a street, or a more protected location is available farther away), the costs in labor and equipment may be even higher.

Applicants have realized that a wireless system may resolve these issues: the insulation on walls 21 may retain its integrity; the time and costs required for installation may be reduced; and the remote network unit may be moved to a safer, more convenient location. It will be appreciated that a wireless system may be advantageous regardless of whether or not it is retrofitted in an existing manhole 20 or installed as part of an original installation of a manhole 20. In either situation, the exposure to integrity issues, higher installation costs and breakage by passersby may be reduced.

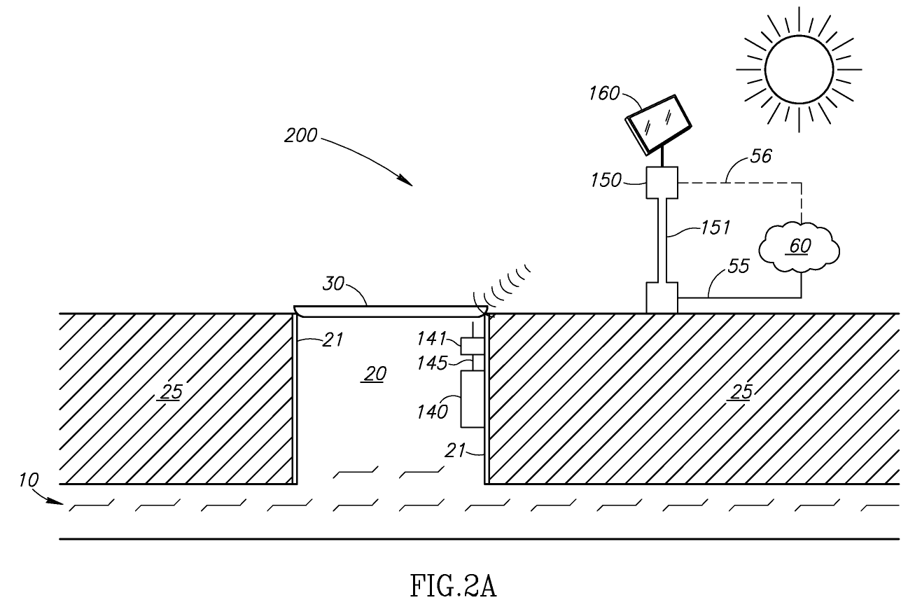

FIG. 2A, to which reference is now made, illustrates a novel wireless sensor installation 200, designed and constructed in accordance with a preferred embodiment of the present invention. As in the prior art, manhole 20 comprises insulated walls 21 and provides access to sewage line 10 underneath ground 25. It will be appreciated that insulated walls 21 may be insulated to prevent seepage of liquids from manhole 20. Manhole cover 30 covers manhole 20. It will be appreciated that, as in the prior art, sewage line 10 may be exemplary; the present invention may also provide a solution for non sewage wastewater systems as well. System 200 may also comprise sensor pack 140, which may be connected to a wireless communication unit 141 via cable 145. Remote network unit 150 may be located ten to several hundred meters away from communication unit 141.

Applicants have realized that it may be problematic to attach monitoring units such units 140 and/or 141 to manhole cover 30. Since manhole covers 30 tend to be quite heavy, any attached equipment may likely be damaged when it is opened. Installations immediately beneath manhole covers 30 may present another problem by obstructing access to manhole 20. If and when a manhole 20 may require servicing, an installation technician may have to accompany the maintenance worker in order to remove and reinstall the monitoring units as required. Therefore in accordance with a preferred embodiment of the present invention, sensor pack 140 and communication unit 141 may be affixed to wall 21.

It will be appreciated that it may not be required to breach the insulation of wall 21 to place units 140 and 141. For example, units 140 and 141 may be attached to wall 21 with an adhesive, or with short screws that do not go entirely through the insulation on wall 21. Alternatively, as ladders are typically installed in manholes 20, units 140 and 141 may be attached to a ladder (not shown). In any case, it will be appreciated that communication unit 141 and/or sensor pack 140 may be positioned relatively close to wall 21, thus providing the additional benefit of leaving a generally unobstructed path for a maintenance worker to descend into manhole 20 and perform maintenance work as required typically without having to remove and reinstall unit 141 and/or pack 140. It will also be appreciated that by installing units 140 and 141 lower in manhole 20, they may be generally protected from damage incurred by opening and closing cover 30.

The invention may be implemented using a modular approach. For example, by separating the functionality of unit 141 from that of sensor pack 140 costs may be reduced. A single unit (141) that may be connected to variety of sensor packs (140) or even several of them at the same time. The benefits may include reduced cost of manufacture as the same unit 141 may be used for a variety of implementations; and flexibility in installation: unit 141 may remain in use if and when the type of sensor used is changed or if sensor pack 140 may be upgraded/replaced for maintenance. Accordingly, sensor pack 140 may comprise a variety of sensors to measure, for example, sewage level, acidity, toxicity, rate of flow and/or opening of cover 30. The functionality of sensor pack 140 may thusly be configured according to the requirements of a specific installation. Sensor pack 140 may operate in a manner generally similar to that of sensor pack 40. However, instead of transferring sensor data externally via access line 45, sensor pack 140 may be connected through cable 145 to wireless communication unit 141. Communication unit 141 may then transmit the data wirelessly to network unit 150. The communication unit 141 may be embedded with the sensor pack 140, so cable 145 may actually be implemented on an internal data bus within a single unit.

As will be disclosed hereinbelow, in accordance with a preferred embodiment of the present invention, system 200 may be configured to provide continuous monitoring, event based reporting, or a combination of both. For example, sensor pack 140 may comprise an ultra-sonic sensor suitable for providing continuous data regarding the level and/or flow of water in sewage line 10. In accordance with an alternative preferred embodiment of the present invention, a sensor that may provide continuous monitoring may also provide event based or periodic monitoring reports as well. For example, an ultrasonic monitor may continuously monitor the depth of water in manhole 20. At the end of a day (or any other defined period) it may report a current, average and/or maximum/minimum daily depth. It may also report a threshold event as it occurs, for example, if the water exceeds a defined depth.

Such data may be used as input for a software application to calculate required pipe widths for sewage line 10 and/or to provide baseline statistics useful for determining future requirements for other installations. Sensor pack 140 may also comprise sensors suitable for detecting “threshold” events, such as flooding, unusual levels of water acidity/toxicity and an opening of manhole cover 30.

Reference is now made to FIG. 2B. In accordance with another preferred embodiment of the present invention, a multiplicity of sensor packs 140 may be installed in a single manhole 20. For example, sensor pack 140A may be installed relatively deep in manhole 20 such that it may monitor the flow of sewage line 10. Sensor pack 140B may be located higher up in a position to monitor flood conditions and/or whether or not manhole cover 30 may be opened. Multiple sensor packs 140 may also be used as backups. For example, sensor pack 140B may provide data if and when sensor pack 140A may cease to operate reliably. Alternatively, multiple packs 140 may operate in parallel to ensure an uninterrupted data stream in case of unit failure. Multiple packs 140 may also be configured to provide both event based and continuous reporting. For example, one sensor pack 140 may comprise a floatation device for event-based reporting; while a second pack 140 may comprise an ultra-sonic sensor for continuous reporting of water depth.

As shown in FIG. 2B, each of the multiple sensor packs 140 may be connected to a separate communication unit 141; sensor pack 140A may be connected to communications unit 141A, and sensor pack 140A may be connected to communications unit 141A. Alternatively, they may be connected to a single communication unit 141. For example, both sensor pack 140A and sensor pack 140B may be connected to communications unit 141B. When multiple communications units 141 may be used in a single manhole 20, a first unit 141 may use a second unit 141 as a relay to transmit to network unit 150. For example, communications unit 141A may relay data to communications unit 141B. Alternatively, each communications unit 141 may transmit directly to network unit 150.

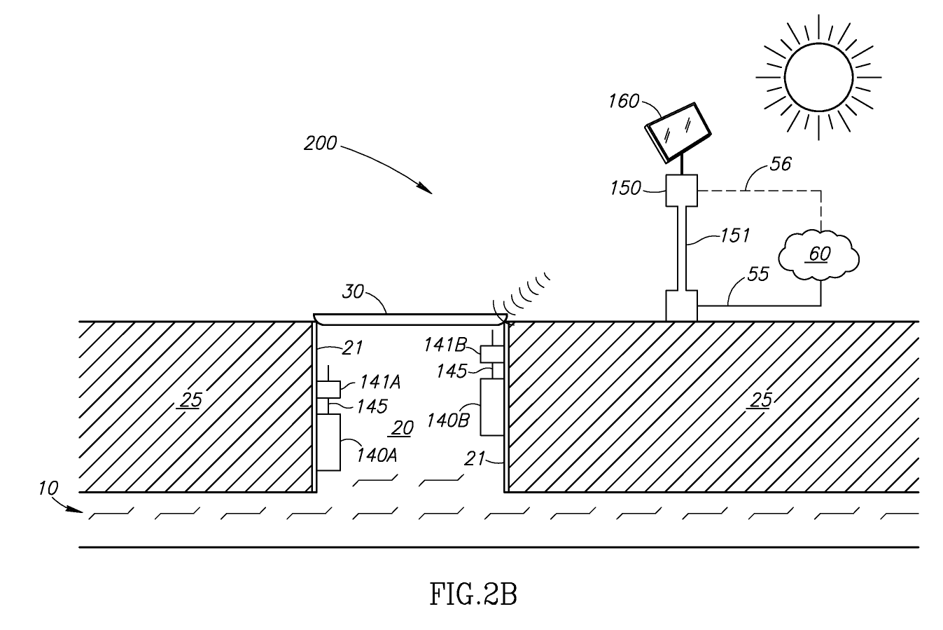

FIG. 3 is a block diagram of electronic elements of an exemplary communication unit 141. Unit 141 may have a housing designed to be mounted onto wall 21. The housing may be completely sealed from elements found in sewage such that it can continue to operate in the hostile environment of manhole 20.

In general, communication unit 141 may comprise an I/O unit 160, to interface with one or more sensor pack 140, a micro controller 165 to handle the data received from sensor pack 140 and to package the data according to a network protocol, and an RF unit 170 to handle the transmission of the sensor data. Communications unit 141 may also comprise power and data modules 175 and memories 180 for ongoing operation. It will be appreciated memories 180 may be any suitable type of memory, including, for example, EEPROMs and/or flash memory. For applications which may require control of the sensor pack 140 and/or the communication unit, RF unit 170 may comprise a transceiver 171. In these embodiments, the micro controller may also process commands such as might be received from a central control station via RF unit 170. In response to these commands, microcontroller 165 may send specific data from a specific sensor 140, send a command signal to a sensor 140, etc. For example, a control command may be received to activate a sensor and/or transmit a current reading immediately. Transceiver 171 may also be used to send control signals to network 60 as necessary, for example: “keep alive” signals and/or “ACK” acknowledgements when receiving data. The antenna (not shown) may be of any suitable size, depending on the RF frequency and on the desired range to network unit 150. Its length may also be a function of the desired mounting location within manhole 20, since there may be a minimum distance from cover 30 to the desired mounting height. The nature of the materials within and outside of manhole 20 as well as the type and size of cover 30 may also impact on the required specifications of the antenna. The antenna and unit 141 may either be sealed together, or packaged as two separate elements. It will be appreciated that by sealing the antenna inside unit 141 it may be less exposed to damage by the elements and during installation and/or manhole maintenance.

In accordance with an exemplary embodiment of the present invention, the RF communication unit may operate in any of non-licensed (ISM) band, such as 300/433/868/900 MHz or 2.4 GHz. It may provide a single frequency or it may work in frequency hopping, as desired. A power amplifier may provide +24 dBm for 915 MHz or 2.4 GHz bands and +20 dBm for the 315/325 MHz band. It will be appreciated that these specifications may be subject to local laws and regulatory bodies. Accordingly, the present invention may include alternative specifications as required.

Communication unit 141 may transmit the sensor data at any desired periodicity. For example, signals may be sent every 1 minute, 15 minutes, 30 minutes or only when the sensors indicate a problem (i.e. the sensors may provide positive/negative data and the communication unit may transmit only when it receives a negative signal or when it receives a delta change from the last status). It will be appreciated that the periodicity and nature of transmissions from unit 141 may be a function of whether system 200 may be configured for continuous monitoring and/or event report reporting. For control applications, the signals may also be sent in response to a request from a central control unit (sometimes refer as an “on demand” request), typically connected at another point of network 60.

Network unit 150 may comprise a wireless communication unit to receive the transmission from communication unit 141. In accordance with a preferred embodiment of the present invention, network unit 150 may be in a raised position relative to manhole 20. For example, unit 150 may be mounted on a pole 151. Pole 151 may represent any pre-existing mounting location, such as a telephone pole, an electric pole, lamp pole or a building roof. Alternatively, pole 151 may be dedicated to installation 200, and erected for that purpose. It will be appreciated that the raised location of unit 150 may also provide a measure of protection from vandalism or unintended damage by passersby. It will also be appreciated that there may be an inherent trade-off in efficiency when mounting unit 150 in such a raised location. It may increase the range from manhole 20 and make that initial transmission more difficult. However it may also reduce the number of the overall communication nodes (relays) as RF tends to have greater range when it is in a raised location.

Network unit 150 may be located up to a few hundred meters away from manhole 20. In accordance with an exemplary preferred embodiment, it may be located up to 40 meters away. However, the exact range may be a function of the power of communication unit 141, the allowed frequency, the terrain and buildings in the neighborhood of manholes 20 and pole 151, and the positioning of manhole 20. For example, a manhole 20 positioned on a sidewalk may have a smaller cover 30 which may be better for communication, whereas in the middle of the street a cover 30 may bigger and heavier and be farther from a mount for unit 150. Manholes 20 may also be in parking spaces, and accordingly a parked vehicle on top of it may interfere with the transmission. It will also be appreciated that, depending on the layout of manholes 20, a single network unit 150 may receive and relay transmissions from more than one communication unit 141.

Network unit 150 may comprise a wireless communication unit (not shown) to transmit the sensor data to network 60 via wireless network connection 56. Alternatively, network line 55 may be used to connect unit 150 to network 60. It will be appreciated that, depending on the layout of manholes 20 and the range between poles 160, units 150 in network 60 may transmit monitoring data to one another, thus aggregating the data received from several units 141 in a single transmission for relay to a control center. Further more, some units 150 or other suitable devices may be positioned in network 60 as relays of such aggregated data without directly receiving data from a unit 141.

Sensor pack 140 and communication unit 141 may be battery powered units, and therefore may not require an external power source. The size and strength of the battery may be a function of the amount of data to transmit as well as the required periodicity of transmission. In accordance with an exemplary embodiment of the present invention, they may use a battery pack comprising one or more 1 Ah lithium batteries to provide several years of continual operation before replacement may be necessary. The battery may be rechargeable or not, depending on the requirements and costs. In accordance with an alternative preferred embodiment of the present invention, the battery may be placed on a separate small board within the housing package in order to facilitate easy replacement of spent batteries.

It will be appreciated that as sensor packs 140 and units 141 may be positioned inside manholes 20, it may be difficult to access them on a regular basis to switch the batteries from which they draw power. Furthermore, in terms of ongoing operation, batteries may represent a significant expense. Accordingly, it may be beneficial whenever possible to extend the life of the installed batteries as much as possible.

Therefore, in accordance with a preferred embodiment of the present invention, battery power may not be turned on at the time of installation. Instead, power may be turned on at a later point in time when the system may first “go live” or when individual units 141 may be brought on line.

One option may be to install an external switch to turn on the power. However, that may expose the system to unauthorized tampering by passersby. Plus, it may also damage the integrity of the sealing of a manhole 20. Alternatively, an internal switch may be installed. In such a case, manhole 20 must be opened (and subsequently resealed) in order for the power to be turned on.

A more advanced option may include, for example, RF activation by a magnet. The magnet would be placed over or near manhole 20 in order to turn on the power. The magnet may cause an internal circuit to be closed, thus activating the power inside manhole 20.

In accordance with a preferred embodiment of the present invention, a magnet may be used in conjunction with an “authorization check” to ensure that the activation was not triggered by a chance encounter with a passing magnet. For example, when unit 141 may be “woken up” by a passing magnet, it may transmit a request for authorization in its immediate vicinity. The technician performing the activation may then respond with a suitable authorization code. If no code is received, unit 141 may “go back to sleep.”

In accordance with another preferred embodiment of the present invention, the technician may carry a portable hub or gateway that may be configured to communicate according to the protocols used by unit 141. The technician may thusly initiate a session with unit 141 and activate it and/or set operating parameters such as a node identification or threshold settings as relevant.

The present invention may also include a number of methods for preserving battery life once the batteries have been activated. For example, when a unit 141 has data to send, it may do so asynchronously by broadcasting the data in the immediate vicinity without going through recognition protocols with network node 150.

In accordance with another preferred embodiment of the present invention, a synchronous protocol may be used. For example, unit 141 may be connected to a network, but instead of constantly sending data, it may just send a minimum number of “keep alive” transmissions to maintain a connection at minimal expense in terms of electrical power. In such a case, unit 141 may only transmit sensor data when a significant event, such as a sewage overflow, occurs. In accordance with another preferred embodiment of the present invention, once unit 141 has transmitted regarding such a significant event, it may only resume transmitting sensor data when a further significant change has been identified.

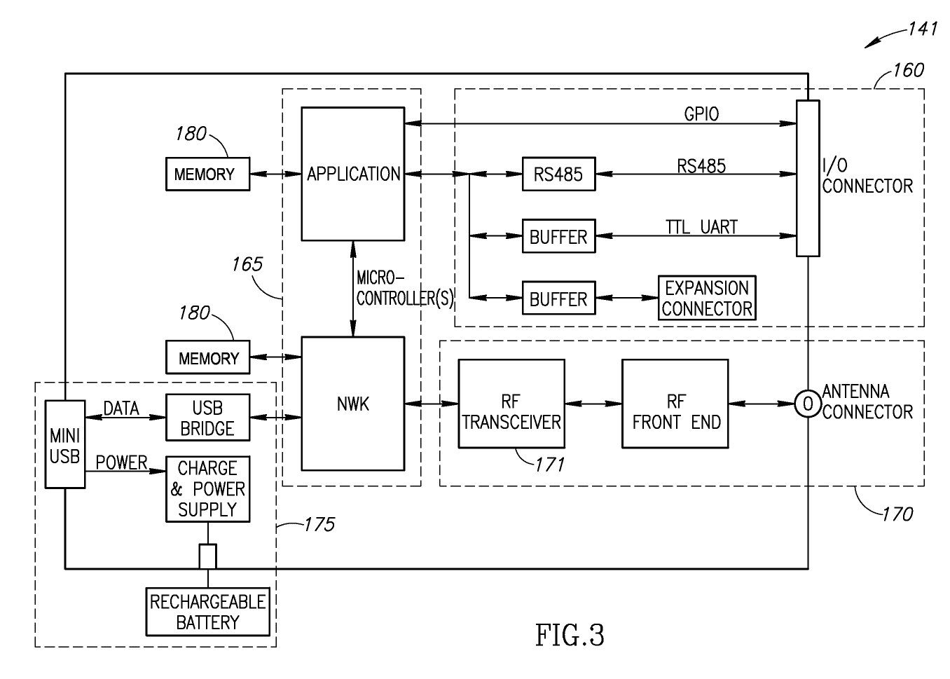

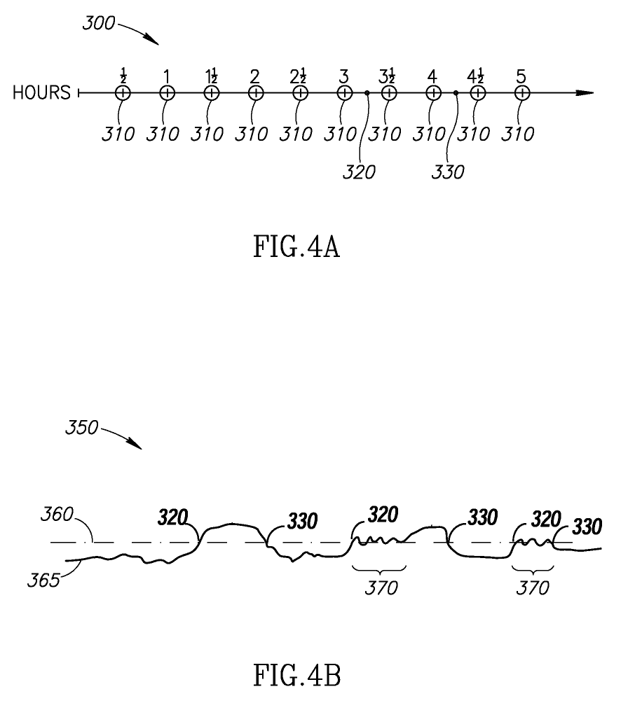

This protocol may be implemented, for example, when sensor pack 140 may comprise a floatation device designed to detect whenever the level of water in manhole 20 rises above or sinks below a given threshold point (usually the location of the “end” of the floatation device). Using floatation devices to check for threshold states may be an inexpensive alternative to periodic depth measurements. The required sensor equipment may cost less and may be simpler to use and maintain. FIG. 4A, to which reference is now made, illustrates an exemplary transmission timeline 300 of synchronous/asynchronous transmissions by unit 141. Scheduled synchronous “keep alive” transmissions 310 may be transmitted, for example, every half hour. Non scheduled asynchronous transmissions 320 and 330 may be transmitted to indicate a new threshold state. For example, transmission 320 may be a brief transmission comprising a “1” to indicate that the water level has exceeded the defined threshold, i.e. there has been a change in the state of the flotation device. Transmission 330 may be a similarly brief transmission comprising a “0” to indicate that the water level has receded below the threshold. In such manner the invention may reduce battery usage and limit unnecessary traffic on network 60. It will be appreciated that the use of floatation devices may be exemplary. Such a protocol may be provided for other event based sensors 140 as well.

Unit 141 may also conserve battery resources by not transmitting when the threshold state changes repeatedly in a short period of time. FIG. 4B, to which reference is now made, shows an exemplary graph 350 of the water level in a manhole 20 over time. Water level 365 may be indicated by a solid line and threshold level 360 may be indicated by a dashed line. It will be appreciated that threshold level 360 may defined by software running in unit 141; sensor pack 140 may forward data regarding the level of water in manhole 20, but as will be described hereinbelow unit 141 may comprise the means necessary for its interpretation. Over time, water level 365 may pass threshold level 360 in either direction, thus necessitating a transmission 320 or 330 as in FIG. 4A.

For example, as described in the embodiment of FIG. 4A, points 320 may indicate a transmission sent when a floatation device indicates that water level 365 may exceed threshold 360. Similarly, points 330 may indicate that water level 365 may have receded below threshold level 360. However, there may be repeated fluctuation periods 370 where water level 365 may go up and down repeatedly in a short period of time. Repeated fluctuation periods 370 may indicate wave action in manhole 20 and not an actual change in water level. Accordingly, in accordance with another preferred embodiment of the present invention unit 141 may transmit transmissions 320/330 when a suitable length of time has passed since the last time the state changed.

Unit 141 may use an hysteresis-like algorithm to identify and ignore fluctuation periods 370. An “event window” may be defined as a minimum wait time between “0”/“1” observations of the floatation device's state. The window may be used to slightly delay a transmission 330 that may indicate a return to a “normal” state in order to prevent repeated transmissions 320 and 330 as water level 365 “straddles” threshold 360. Instead, a transmission 320 may transmitted when fluctuation period 370 starts, but a transmission 330 may not be sent until period 370 and water level 365 may stay lower than threshold level 360 for at least the defined minimum wait time. If the state may change back before the minimum wait time may pass, unit 141 may not transmit, thus saving unnecessary transmissions and also indicating that the “abnormal” state (i.e. the threshold has been exceeded) may still continue.

It will be appreciated that such “minimum wait times” may be either symmetric or non-symmetric. For example, since water levels 365 in excess of threshold level 360 may be generally of more concern to the operators of installation 200, the minimum time to wait after transmitting a transmission 320 (i.e. to signify a return to “normal” conditions after an “event”) may be higher than the time to wait after transmitting a transmission 330.

Unit 141 may also be “dormant” for long periods of time, periodically sending “keep alive” message to maintain network contact and to provide a regular report of its operating status. It will be appreciated that in such manner battery life may be extended. Network traffic may also be reduced and/or scheduled more efficiently. Unit 141 may also be configured not to use its battery unless a triggering event has occurred, for example an event that may indicate an overflow. An exemplary sensor pack 140 may comprise a floatation sensor that may serve to mechanically close a circuit in unit 141 when a certain level is reached. Prior to the triggering event the circuit may be open and there may be no electrical power in unit 141.

Unit 141 may also save ongoing monitoring data that may not be time critical and send it infrequently in aggregated bursts.

In accordance with a preferred embodiment of the present invention, network unit 150 may comprise solar panel 160 for the provision of power to unit 150. Networks units 150 may also comprise rechargeable batteries (not shown) as a backup power source for when solar energy may not be feasible. The solar panels may recharge the batteries as part of the ongoing operation of network units 150.

Network 60 may be any suitable network, such as a WiFi wireless network, WiMAX wireless network, a cellular network, an Ethernet network, a ZigBee network or a proprietary (non-standard) wireless sensor network. An exemplary mesh sensor network is commercially available, under the name Tnet, from Telematics Wireless in Israel. Mesh networks generally provide additional features over other networks such as self-healing, automatic configuration of a new network node into an existing network and easy maintenance. Tnet also provides a low-cost network solution, by using low-cost units such as unit 141 and unit 150. It will be appreciated that Tnet and other suitable technologies may also be used for transmissions between units 141 and 150. Such a mesh network may use a light protocol with low overhead and may afford high reliability while requiring relatively low power usage, thus significantly reducing the costs and complexity of operating and maintaining system 200.

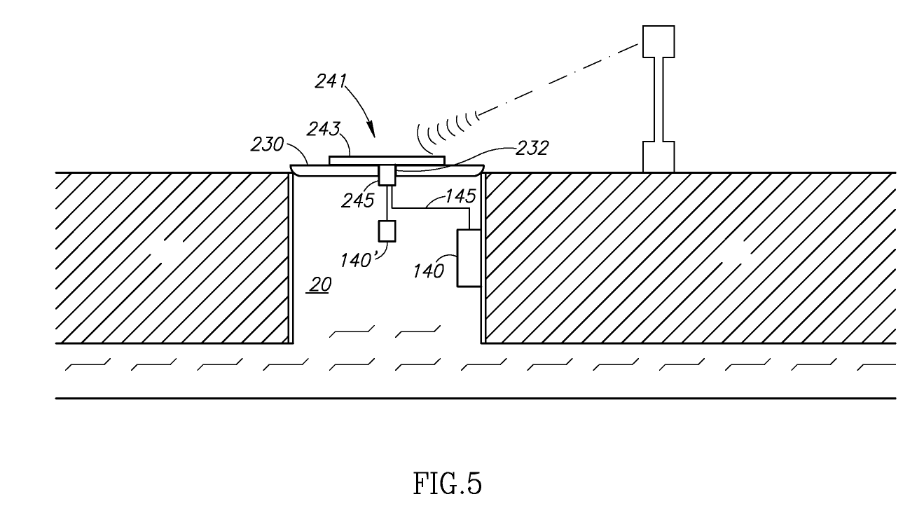

In an alternative embodiment of the present invention, shown in FIG. 5, to which reference is now briefly made, manhole covers 230 may have holes 232 in them into which the communication unit, here labeled 241, may be mounted. Units 241 may have two parts, an antenna 243, located above or mounted in line with, cover 230 and a communication unit 245, which may extend into manhole 20 and may be connected through cable 145 to sensor pack 140. The sensor pack may either be mounted on wall 21 (labeled 140) or not (labeled 140′). In the latter embodiment, sensor pack 140′ is connected to cover 230 through communication unit 241. In either case, unit 241 may provide stronger transmissions, thus enabling network units 150 to be placed further from manholes 20.

In a further embodiment, communication units 141 or 241 may transmit to each other, from one manhole 20 to another manhole 20. This may be particularly useful in areas where there are no pre-existing poles upon which to mount network unit 150, or to reduce the number of network units 150 needed. Similarly, if it is desired to communicate mostly between manholes but the range between manholes is too large, network units 150 may be utilized to extend the range between manholes. For this embodiment, the batteries of communication units 141 or 241 may need to be stronger or to be replaced more frequently.

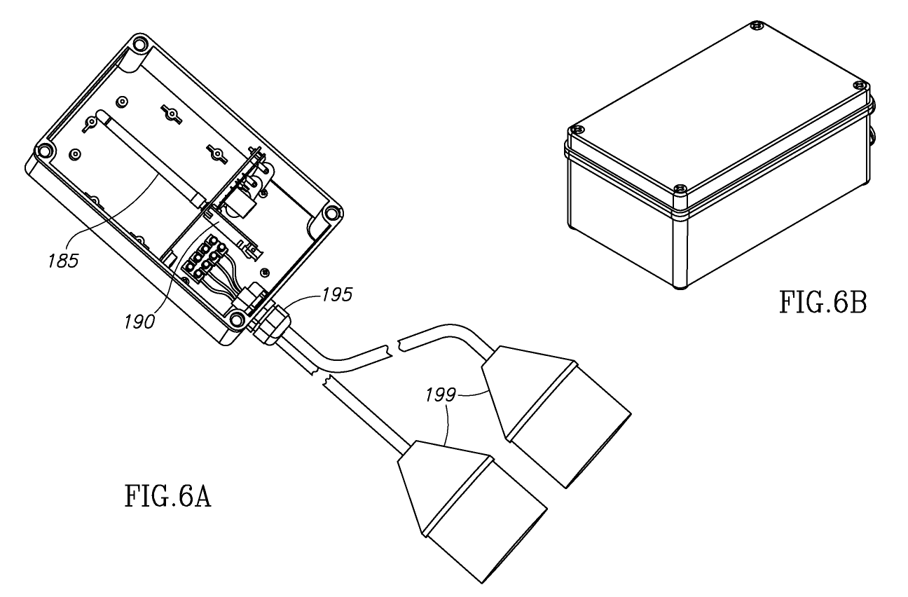

FIG. 6A, to which reference is now made, may represent a schematic illustration of an exemplary unit 141. Unit 141 may comprise a built in antenna 185, a transceiver and microprocessor card 190 such as the above mentioned Tnet platform, and sensor interface 195. It will be appreciated that unit 141 may be also be configured with the transceiver and microprocessor on separate boards. Sensor interface 195 may provide connectivity to an exemplary sensor pack 140 comprising two floats for detecting water level threshold conditions. It will be appreciated that the use of floats is exemplary; as disclosed hereinabove, unit 141 may be implemented in a modular design and accordingly may connect to any suitable monitoring sensors. It will further be appreciated that the internal placement of antenna 185 is also exemplary; as disclosed hereinabove antenna 185 may also be packaged separately from unit 141. Antenna 185 may be either directional or non-directional; the type of antenna used in a given location may be a function of environmental conditions such as the range to unit 150 and maintenance issues. It will furthermore be appreciated that unit 141 may be enclosed in a waterproof container suitable for immersion in a typical sewage or wastewater system. A battery or battery pan may be installed as part of card 190. Alternatively, as disclosed hereinabove, the battery may be placed on a separate small board within unit 141 in order to facilitate easy replacement of spent batteries. It will be appreciated that installing the batteries on a separate card may reduce the likelihood of damage to the more sophisticated and costly card 190 during routine battery maintenance.

FIG. 6B, to which reference is now made, may represent a schematic illustration of the unit 141 of FIG. 6A in a sealed state, ready for installation with a watertight cover to prevent damage to its working components. It will be appreciated that antenna 185 may receive added protection from damage by sealing it within unit 141.

The invention may be implemented in an environment which may have combustible gases. It will be appreciated that by sealing unit 141 the exposure to combustion caused by a spark may be lessened. It will further be appreciated that flotation sensors as disclosed hereinabove may not comprise any electrical elements that may cause sparks. Accordingly, when sensor pack 140 may be configured for threshold level checks there may also be less exposure to combustion.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, microprocessor or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.)

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A manhole monitoring unit comprising
a housing mountable to walls of a closed manhole, without breaching an insulating layer on said walls;
a data processor to receive data from monitoring sensors in said manhole; and
a communication unit at least for transmitting wirelessly said data to an external network unit located above ground.

2. The unit according to claim 1 and wherein said sensors comprise functionality to provide at least one of the following types of data: threshold level condition, water depth, toxicity, acidity, flow rate and whether said closed manhole has been opened.

3. The unit according to claim 1 and wherein said housing is mounted using at least one of the following: adhesive, screws and an assembly for attachment to a ladder.

4. The unit according to claim 1 and wherein said communication unit comprises means to at least communicate with at least one other said manhole monitoring unit.

5. The unit according to claim 4 and wherein said at least one other manhole monitoring unit is located in at least one of the following locations: said manhole and at least one other said manhole.

6. The unit according to claim 1 and wherein said data processor comprises means to control actuators according to high level network commands.

7. The unit according to claim 1 and also comprising means to receive an activation signal.

8. The unit according to claim 7 and wherein said means are at least one of the following: a wireless receiver, a magnet sensor and an activation switch.

9. The unit according to claim 8 and also comprising means to request and receive confirmation of said activation signal.

10. A manhole monitoring and control unit comprising:
a housing mountable to walls of a closed sewage manhole, without breaching said walls;
a data processor to receive data from monitoring sensors in said manhole and to control actuators according to high level network commands; and
a communication unit for transmitting wirelessly said data to an external network unit located above ground and receiving commands.

11. The unit according to claim 10 and wherein said sensors comprise functionality to provide at least one of the following types of data: threshold level condition, water depth, toxicity, acidity, flow rate and whether said closed manhole has been opened.

12. The unit according to claim 10 and wherein said housing is mounted using at least one of the following: adhesive, screws and an assembly for attachment to a ladder.

13. The unit according to claim 10 and wherein said communication unit comprises means to at least communicate with at least one other said manhole monitoring unit.

14. The unit according to claim 13 and wherein said at least one other manhole monitoring unit is located in at least one of the following locations: said manhole and at least one other said manhole.

15. The unit according to claim 10 and also comprising means to receive an activation signal.

16. The unit according to claim 15 and wherein said means are at least one of the following: a wireless receiver, a magnet sensor and an activation switch.

17. The unit according to claim 16 and also comprising means to request and receive confirmation of said activation signal.

18. A remote network unit comprising:
a communication unit to relay a transmission from a manhole monitoring unit to a network;
rechargeable batteries; and
a solar panel to provide power to said network unit and charge said batteries.

19. The unit according to claim 18 and wherein said communication unit comprises:
a wireless receiver to receive said transmission from a manhole monitoring unit; and
a network communication unit to connect to said network via a connection, said connection being at least one of wireless and cable.

20. The unit according to claim 19 and wherein said network is at least one of a WiFi wireless network, a cellular network, an Ethernet network, or a wireless sensor network.

21. A method for monitoring liquid drainage in a manhole comprising:
receiving on a communications unit monitoring data from at least one sensor pack located in said manhole, wherein said communications unit is located in said manhole; and
sending said data via wireless transmission to a remote network unit for relay to a central control center.

22. The method according to claim 21 and also comprising receiving at least one transmission of monitoring data from a second communications unit, said second communications unit located in at least one of the following locations: said manhole and at least one other said manhole.

23. The method according to claim 21 and wherein said sending comprises transmitting said monitoring data to a second communications unit, said second communications unit located in at least one of the following locations: said manhole and at least one other said manhole.

24. The method according to claim 21 and also comprising periodically entering a dormant state to conserve use of resources.

25. The method according to claim 21 and also comprising transmitting said monitoring data in response to a threshold event indicated by said monitoring data.

26. The method according to claim 25 and also comprising defining at least one event window for ignoring repeated changes of states for said threshold event.

27. The method according to claim 26 and also comprising defining different lengthed said event windows for the beginning and end of a non normal state for said threshold event.

28. The method according to claim 21 and wherein said sending comprises:
storing said monitoring data and;
transmitting said stored monitoring data on a periodic basis.

29. The method according to claim 21 and also comprising:
storing said monitoring data;
summarizing said stored monitoring data; and
transmitting said summarized stored monitoring data on a periodic basis.

30. The method according to claim 21 and also comprising receiving an activation signal to commence operation.

31. The method according to claim 30 and wherein said receiving an activation signal comprises at least one of the following: detecting a magnet, receiving a wireless signal, and detecting a change in an activation switch.

32. The method according to claim 21 and also comprising controlling actuators according to high level network commands.

33. The method according to claim 21 and also comprising receiving a second set of said monitoring data on a second communications unit located in said manhole.

34. The method according to claim 33 and wherein said receiving of said second set is continuous.

35. The method according to claim 33 and also comprising activating said second communications unit in the event of failure of said first communications unit.
